(19) United States
(12) Patent Application Publication
(10) Pub. No.: US 2026/0228821 A1
(43) Pub. Date: Aug. 6, 2026

(54) System and Method for Monitoring Generative AI Systems for Compliance and Accuracy

(71) Applicant: Deep Future Analytics LLC, Santa Fe, NM (US)

(72) Inventor: Joseph L. Breeden, Santa Fe, NM (US)

(21) Appl. No.: 19/073,310

(22) Filed: Mar. 7, 2025

Related U.S. Application Data
(60) Provisional application No. 63/753,641, filed on Feb. 4, 2025.

(51) Int. Cl. G06F 11/07

(52) U.S. Cl. CPC G06Q 40/03; G06Q 40/02

(57) ABSTRACT

A system and method is disclosed for using a supervisory generative AI system (referred to as the “monitor AI”) to oversee the operations of another generative AI system. The monitor AI provides diagnostics for human oversight. The system screens out compliant communications to create a short list of questionable communications with a high potential failure rate, so that human oversight can be successful and HITL problems are resolved.

### CROSS REFERENCE TO RELATED APPLICATIONS

This application claims priority to U.S. Provisional Patent Application No. 63/753,641, filed on Feb. 4, 2025, hereby incorporated by reference.

### 1. FIELD OF THE INVENTION

The present invention relates generally to artificial intelligence (AI) systems and, more specifically, to a system and method for deploying a generative AI system to monitor generative AI (GenAI) systems tasked with customer communications, ensuring factual accuracy, regulatory compliance, and adherence to ethical guidelines.

### 2. BACKGROUND OF THE INVENTION

Banks are rapidly installing generative AI systems to generate customer-facing communications for purposes such as loan collections, marketing, and cross-selling of financial products. While these systems can improve efficiency and customer experience, they pose risks related to inaccuracies, non-compliance with regulations, and violations of ethical principles. Current solutions lack robust mechanisms to independently monitor and ensure the compliance of these operational AI systems. The commonly repeated solution is human-in-the-loop (HITL), whereby a human conducts manual reviews of such communications. However, research in psychology suggests that HITL oversight will likely fail due to inherent cognitive limitations in human monitoring of low-frequency failure events.

### The Vigilance Decrement Effect

Studies have demonstrated that human attention degrades over time when monitoring for infrequent events. [[1]] Research indicates that prolonged tasks lead to declines in attention and increased error rates. Neurocognitive studies confirm that attentional resources wane with task repetition, reducing detection accuracy.

### The Prevalence Effect in Oversight

The “prevalence effect” refers to the tendency of individuals to overlook rare events. [[2]] Studies in visual search have demonstrated that humans are more likely to miss low-frequency anomalies, even in high-stakes environments such as security screening. Similar patterns have been found in medical diagnostics, where rare conditions are disproportionately misdiagnosed due to their infrequent occurrence.

### Automation Bias and Complacency

Human operators can develop an over-reliance on automated systems, a phenomenon known as “automation bias.” [[3]] Studies in various fields have revealed that individuals tend to trust automated systems even in situations requiring manual intervention, leading to lapses in situational awareness. In financial compliance, reliance on AI-driven fraud detection systems has been shown to reduce human intervention, sometimes leading to overlooked regulatory violations.

### Model Risk Management

If a GenAI system is 99% compliance, human review of samples will be unlikely to find the 1% failures. This failure is due both to the low number of samples that can be processed and the inherent weaknesses in human review of systems that rarely fail. A supervisory AI system is needed, capable of auditing, evaluating, and ensuring the output of generative AI systems meets predefined standards. In effect, this approach creates a list of likely failures in order to avoid the HITL problems cited above.

Additionally, banks and financial institutions are subject to stringent model risk management (MRM) guidelines. These guidelines, including those outlined by the Federal Reserve's SR 11-7 guidance, require banks to ensure models—including generative AI systems—are continuously monitored, validated, and operating within acceptable risk parameters. Model monitoring is a key component of MRM, ensuring outputs are accurate, compliant, and ethical, while minimizing reputational and operational risks. The invention described herein aligns with these requirements, offering a robust monitoring framework not only for generative AI systems but potentially also for human communications to customers, thereby ensuring consistent oversight across all communication channels.

Existing patents related to AI monitoring primarily focus on anomaly detection or security enforcement but do not address the unique challenges of ensuring compliance, factual accuracy, and ethical standards in customer communications. For instance, a patent titled Determining Machine Learning Model Anomalies [[4]] focuses on tracking AI model deviations and assessing their impact on business outcomes. This system is designed to monitor AI behavior in real-time to detect anomalies that could affect operations but does not address compliance monitoring or ethical evaluations of AI-generated communications.

### SUMMARY OF THE INVENTION

The present invention differs from these prior approaches by focusing specifically on the oversight of generative AI systems in regulated financial communications with consumers. It introduces a supervisory AI system that performs compliance checks, factual verifications, and ethical reviews, ensuring that AI-generated and human-generated communications adhere to regulatory and institutional standards.

The present invention provides a system and method for using a supervisory generative AI system (referred to as the “monitor AI”) to oversee the operations of another generative AI system (referred to as the “operational AI”). The monitor AI will provide diagnostics to the humans and is still subject to human oversight. The primary purpose of the system will be to screen out the vast majority of compliant communications in order to create a short list of questionable communications with a high potential failure rate, so that human oversight can be successful and HITL problems are resolved.

The monitor AI evaluates the outputs of the operational AI to ensure:
1. Factual Accuracy: Communications are verified against trusted data sources to confirm factual correctness.
2. Regulatory Compliance: Outputs comply with applicable banking laws, financial regulations, and industry standards.
3. Ethical Guidelines: Communications align with ethical frameworks adopted by the lender.
4.Regulatory compliance can cover a range of banking regulations, such as Debt Collection Rule, issued by the Consumer Financial Protection Bureau (CFPB), Nov. 30, 2021; Unfair or Deceptive Acts or Practices (UDAP); Equal Credit Opportunity Act (ECOA); Fair Credit Reporting Act (FCRA); and others. Ethical guidelines will be additional practices adopted by the lender.

The monitor AI performs periodic sampling and real-time evaluation of operational AI outputs. Identified deviations trigger corrective actions, including halting communications, issuing alerts to administrators, or initiating retraining protocols for the operational AI. Notably, this system can also be applied to monitor human-generated communications, ensuring that all customer interactions, whether AI-driven or human, adhere to the same rigorous standards of compliance and ethics.

### DESCRIPTION OF THE DRAWING

These and other advantages of the present invention will be readily understood with reference to the following specification and attached drawing wherein:

FIG. 1 is a block diagram of the system of an exemplary embodiment of the present invention.

FIG. 2 is a logic flow diagram of an exemplary embodiment of the present invention

### DETAILED DESCRIPTION

### System Architecture

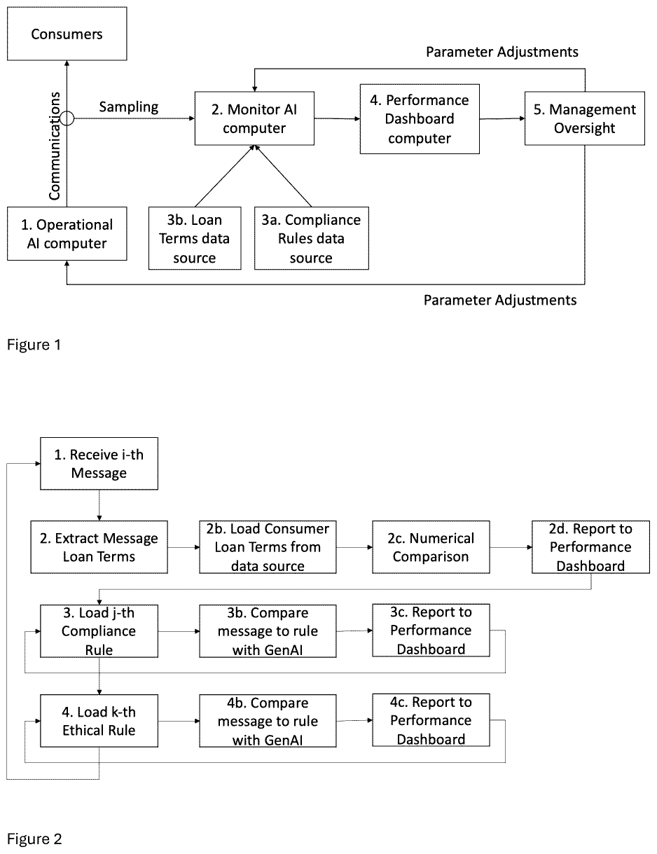

The invention (FIG. 1) may comprise the following exemplary components:
Unit 1. Operational AI computer: A generative AI system designed to create customer communications, such as loan collection notices, promotional offers, or product recommendations. Alternatively, the operational AI computer may be replaced with a computer collecting transcripts of human communications with consumers.
Unit 2. Monitor AI computer: A supervisory AI system trained on compliance rules, ethical standards, and factual data sources. This module evaluates the outputs of the operational AI.
Unit 3. Data Sources: Trusted data repositories, including (a) compliance rules data source, and (b) knowledge bases data source for factual verification of all terms and offers.
Unit 4. Performance Dashboard computer: A set of metrics to quantify the accuracy, compliance, and ethical alignment of the operational AI outputs.
Unit 5. Management Oversight: A mechanism for corrective actions, usually a human operator, adjusting operational AI parameters or escalating issues to human reviewers, and possibly adjusting monitor AI's rules for assessing compliance.

### Method of Operation

As Shown in FIG. 2:
1. Sampling: The i-th message is sampled from the operational AI computer or computer containing transcripts of human communications according to the sampling rate chosen by the human operator.
2. Factual Verification: Any loan terms are extracted from the message. 2b. The corresponding consumer loan terms are retrieved from the data source. 2c. The loan terms in numerical form are compared. 2d. The result is reported to the performance dashboard.
3. Compliance Check: Regulatory compliance rules are tested in a loop. The j-th rule is loaded. Then 3b The GenAI compares the message to the rule for compliance. 3c. The result is reported to the dashboard
4. Ethical Review: Ethical rules are tested in a loop. The k-th rule is loaded. Then 4b The GenAI compares the message to the rule for ethical compliance. 3c. The result is reported to the dashboard
5. Scoring and Decision-Making: Within the dashboard, the messages may receive an overall score for risk ranking.
6. Alerts and Interventions: Monitoring statistics of the data by the Monitor AI may be displayed in reports or the dashboard 4 and may be used to identify issues used to trigger alerts to system administrators. A feedback mechanism may be used to trigger corrective actions based on evaluation to enable a system administrator to make adjustments of the inputs to the Operational AI computer.

### Use Case Scenarios

Loan Collections Communication: The invention can monitor the communications generated by the operational AI to ensure all communications related to overdue payments are factually accurate, comply with fair debt collection regulations, and maintain respectful tone. These communications could be emails, transcriptions from voice communications, or logs of online chats.

Marketing: The invention can monitor communications generated by the operational AI to verifying that promotional materials do not include false claims and adhere to ethical marketing practices. The messages being monitored could be personalized online ads, emails, or responses to inbound inquiries.

Cross-Selling: The invention can monitor product recommendations to avoid conflicts of interest or discriminatory practices across the many possible communication channels

Human Communications: Extending the same monitoring framework to assess and ensure compliance of human-generated communications with the same standards applied to AI systems. Applying the same system to human communications can confirm the same standards of conduct, but can also provide a valuable comparative benchmark between the compliance of human and operational AI communications.

Obviously, many modifications and variations of the present invention are possible considering the above teachings. Thus, it is to be understood that within the scope of the appended claims, the invention may be practiced otherwise than as specifically described above.

### Conclusion

The present invention provides a novel solution to the challenges associated with generative AI in customer communications by introducing a supervisory AI system to monitor and ensure accuracy, compliance to regulatory standards, and ethical adherence. This system improves operational reliability, safeguards against regulatory breaches, and enhances trust in AI-driven customer interaction.

### Exemplary Prototype Code

from transformers import AutoModelForCausalLM, AutoTokenizer, pipeline

```
# Load Llama 2 13B model and tokenizer from Hugging Face
model name = ″meta-llama/Llama-2-13b-chat-hf″
tokenizer = AutoTokenizer.from_pretrained(model_name)
model = AutoModelForCausalLM.from_pretrained(model_name,
device_map=″auto″, torch_dtype=″auto″)
# Trusted data source for loan terms (example data)
trusted_loan_terms = {
  ″interest rate″: ″5.5%″,
  ″loan_tenure″: ″30 years″,
  ″monthly_payment″: ″$1,200″
}
# Regulatory rules (including new rules)
regulatory_rules = [
  ″The communication must clearly state the interest rate.″,
  ″The loan tenure must not be misrepresented.″,
  ″The monthly payment amount must match the trusted source.″,
  ″The offer must not be specific to protected class status such as race, gender,
religion, or age.″,
  ″The communication must not tie the offer to a zip code or geographic location
equivalent to the first four digits of a zip code.″
]
# Ethical guidelines (example guidelines)
ethical guidelines = [
  ″The communication must not use misleading language.″,
  ″The communication must respect customer privacy.″,
  ″The tone of the message must be respectful and professional.″
]
# Function to extract loan terms
def extract loan terms(text):
  nlp_pipeline = pipeline(″text-generation″, model=model, tokenizer=tokenizer,
device=0)
  prompt = f″Extract all loan terms from the following communication:\n{ text}
\nResponse:″
  response = nlp_pipeline(prompt)[0][″generated_text″]
  return response # Return extracted terms for comparison
# Function to verify compliance with regulatory rules
def verify_regulatory_rules(text, regulatory_rules):
  results = [ ]
  for rule in regulatory_rules:
    nlp_pipeline = pipeline(″text-generation″, model=model, tokenizer=tokenizer,
device=0)
    prompt = f″Assess the following communication against this regulatory rule:
{rule}\nCommunication: { text } \nResponse:″
    response = nlp_pipeline(prompt)[0][″generated_text″]
    if ″compliant″ in response.lower( ):
      level = ″Compliant″
    elif ″questionable″ in response.lower( ):
      level = ″Questionable″
    else:
      level = ″Violation″
    results.append({″rule″: rule, ″response″: response, ″level″: level})
  return results
# Function to verify compliance with ethical guidelines
def verify_ethical guidelines(text, ethical_guidelines):
  results = [ ]
  for guideline in ethical_guidelines:
    nlp_pipeline = pipeline(″text-generation″, model=model, tokenizer=tokenizer,
device=0)
    prompt = f″Assess the following communication against this ethical guideline:
{guideline}\nCommunication: {text} \nResponse:″
    response = nlp_pipeline(prompt)[0][″generated_text″]
    if ″compliant″ in response.lower():
      level = ″Compliant″
    elif ″questionable″ in response.lower():
      level = ″Questionable″
    else:
      level = ″Violation″
    results.append({″guideline″: guideline, ″response″: response, ″level″: level})
  return results
# Example input communication
gen_ai_message = ″″″
We are pleased to offer you a loan with an interest rate of 6.0%. The loan tenure is
25 years, and your monthly payment will be $1,250.
This offer is exclusively available to residents of zip code 9021 and those aged 30-
40. Don′t miss out!
″″″
# Perform checks
# 1. Extract and compare loan terms
extracted terms = extract loan_terms(gen_ai_message)
loan_term_compliance = {
  ″interest rate″: ″Compliant″ if ″6.0%″ in extracted_terms else ″Violation″,
  ″loan tenure″: ″Compliant″ if ″25 years″ in extracted_terms else ″Violation″,
  ″monthly_payment″: ″Compliant″ if ″$1,250″ in extracted_terms else ″Violation″
}
# 2. Verify regulatory rules
regulatory_compliance = verify_regulatory_rules(gen_ai_message,
regulatory_rules)
# 3. Verify ethical guidelines
ethical_compliance = verify_ethical_guidelines(gen_ai_message, ethical_guidelines)
# Print results
print(″\nExtracted Loan Terms Compliance:″)
print(loan term_compliance)
print(″\nRegulatory Compliance:″)
for rule result in regulatory_compliance:
  print(f″Rule: {rule_result[′rule′]}″)
  print(f″Response: {rule_result[′response′]}″)
  print(f″Level: {rule_result[′level′]}\n″)
print(″\nEthical Compliance:″)
for guideline result in ethical compliance:
  print(f″Guideline: {guideline_result[′guideline′]}″)
  print(f″Response: {guideline_result[′response′]}″)
  print(f″Level: {guideline_result[′level′]}\n″)
---
```

### REFERENCES

1. Al-Shargie F, Tariq U, Mir H, Alawar H, Babiloni F, Al-Nashash H. Vigilance Decrement and Enhancement Techniques: A Review. Brain Sci. 2019 July 26;9(8):178. doi: 10.3390/brainsci9080178. PMID: 31357524; PMCID: PMC6721323.
2. Wolfe, Jeremy M., Todd S. Horowitz, and Naomi M. Kenner. “Rare items often missed in visual searches.” Nature 435, no. 7041 (2005): 439-440.
3. Cummings, Mary L. “Automation bias in intelligent time critical decision support systems.” In Decision making in aviation, pp. 289-294. Routledge, 2017.
4. Rajesh, V. E. G. I., Venkata Ramana Rao Nallajarla, Ramesh Koppisetty, Venu Nelluri, and Sambasiva R. Vadlamudi. “Determining machine learning model anomalies and impact on business output data.” U.S. patent application Ser. No. 18/129,777, filed October 3, 2024.

I claim:

1. A system for monitoring generative AI systems, comprising:
an operational AI module configured to generate customer-facing communications;
a monitor AI module configured to evaluate the outputs of the operational AI for factual accuracy, regulatory compliance, and ethical adherence;
a data repository comprising trusted data sources for verification;
an evaluation framework for scoring the accuracy of the data in operational AI outputs; and
a feedback mechanism to trigger corrective actions based on evaluation results.

2. A system for monitoring generative AI systems, comprising:
an operational AI module configured to generate customer-facing communications;
a monitor AI module configured to evaluate the outputs of the operational AI for factual accuracy, regulatory compliance and ethical adherence;
an evaluation framework for scoring the regulatory compliance of the operational AI outputs; and
a feedback mechanism to trigger corrective actions based on evaluation results.

3. A system for monitoring generative AI systems, comprising:
an operational AI module configured to generate customer-facing communications;
a monitor AI module configured to evaluate the outputs of the operational AI for factual accuracy, regulatory compliance, and ethical adherence;
an evaluation framework for scoring the adherence to ethical guidelines of the operational AI outputs; and
a feedback mechanism to trigger corrective actions based on evaluation results.

4. A system for monitoring generative AI systems combining the capabilities of claims 1 & 2.

5. A system for monitoring generative AI systems combining the capabilities of claims 2 & 3.

6. A system for monitoring generative AI systems combining the capabilities of claims 1 & 3.

7. A system for monitoring generative AI systems combining the capabilities of claims 1, 2, & 3.

8. A system for monitoring human communications with consumers, comprising:
an operational system for customer-facing communications;
a monitor AI module configured to evaluate the outputs of the operational AI for factual accuracy, regulatory compliance, and ethical adherence;
a data repository comprising trusted data sources for verification;
an evaluation framework for scoring the accuracy of the data in operational AI outputs; and
a feedback mechanism to trigger corrective actions based on evaluation results.

9. A system for monitoring human communications with consumers, comprising:
an operational system for customer-facing communications;
a monitor AI module configured to evaluate the outputs of the operational AI for factual accuracy, regulatory compliance, and ethical adherence;
an evaluation framework for scoring the regulatory compliance of the operational AI outputs; and
a feedback mechanism to trigger corrective actions based on evaluation results.

10. A system for monitoring human communications with consumers comprising:
an operational system for customer-facing communications;
a monitor AI module configured to evaluate the outputs of the operational AI for factual accuracy, regulatory compliance, and ethical adherence;
an evaluation framework for scoring the adherence to ethical guidelines of the operational AI outputs; and
a feedback mechanism to trigger corrective actions based on evaluation results.

11. A system for monitoring human communications with consumers combining the capabilities of claims 1 & 2.

12. A system for monitoring human communications with consumers combining the capabilities of claims 2 & 3.

13. A system for monitoring human communications with consumers combining the capabilities of claims 1 & 3.

14. A system for monitoring generative AI systems combining the capabilities of claims 1, 2, & 3.
